(19) United States
(12) Patent Application Publication
(10) Pub. No.: US 2024/0241086 A1
(43) Pub. Date: Jul. 18, 2024

(54) FLUIDICALLY COUPLING OF SAMPLING AND SEPARATION PATHS

(71) Applicant: Agilent Technologies, Inc., Santa Clara, CA (US)

(72) Inventors: Thomas Ortmann, Straubenhardt/Ottenhausen (DE); Dominik Ruf, Baden Weurttemberg (DE)

(21) Appl. No.: 18/562,216

(22) PCT Filed: May 17, 2022
(86) PCT No.: PCT/IB2022/054575

§ 371 Date: Nov. 17, 2023

(30) Foreign Application Priority Data
May 21, 2021 (GB) 2107310.1

(51) Int. Cl. G01N 30/22; G01N 30/20

(52) U.S. Cl. CPC G01N 30/22; G01N 2030/201; G01N 2030/202; G01N 2030/204; G01N 2030/207

(57) ABSTRACT

A switching unit is configured for selectively fluidically coupling a sampling volume, a sampling drive, a mobile phase drive, and a separating device. In a sample load configuration, the switching unit is configured for fluidically coupling the sampling volume and the sampling drive, for moving the fluidic sample into the sampling volume. In a decouple configuration, the switching unit is configured for fluidically coupling the sampling volume between the sampling drive and the separating device, while the mobile phase drive is fluidically decoupled from the separating device. In a sample introduction configuration, the switching unit is configured for fluidically coupling the mobile phase drive, the sampling volume, and the separating device for introducing at least an amount of the fluidic sample stored in the sampling volume into the mobile phase for fluid separation by the separating device.

### CROSS-REFERENCE TO RELATED APPLICATIONS

This application is the national stage under 35 U.S.C. 371 of International Application No. PCT/IB2022/054575, filed on May 17, 2022; which claims priority to UK Application No. 2107310.1, filed on May 21, 2021; the entire contents of which are incorporated by reference herein.

### TECHNICAL FIELD

The present invention relates to fluidic coupling of sampling and separation path, in particular for chromatographic sample separation.

### BACKGROUND

In high performance liquid chromatography (HPLC), a liquid has to be provided usually at a very controlled flow rate (e.g. in the range of microliters to milliliters per minute) and at high pressure (typically 20-100 MPa, 200-1000 bar, and beyond up to currently 200 MPa, 2000 bar) at which compressibility of the liquid becomes noticeable. For liquid separation in an HPLC system, a mobile phase comprising a sample fluid (e.g. a chemical or biological mixture) with compounds to be separated is driven through a stationary phase (such as a chromatographic column packing), thus separating different compounds of the sample fluid which may then be identified. The term compound, as used herein, shall cover compounds which might comprise one or more different components.

The mobile phase, for example a solvent, is pumped under high pressure typically through a chromatographic column containing packing medium (also referred to as packing material or stationary phase). As the sample is carried through the column by the liquid flow, the different compounds, each one having a different affinity to the packing medium, move through the column at different speeds. Those compounds having greater affinity for the stationary phase move more slowly through the column than those having less affinity, and this speed differential results in the compounds being separated from one another as they pass through the column. The stationary phase is subject to a mechanical force generated in particular by a hydraulic pump that pumps the mobile phase usually from an upstream connection of the column to a downstream connection of the column. As a result of flow, depending on the physical properties of the stationary phase and the mobile phase, a relatively high-pressure drop is generated across the column.

The mobile phase with the separated compounds exits the column and passes through a detector, which registers and/or identifies the molecules, for example by spectrophotometric absorbance measurements. A two-dimensional plot of the detector measurements against elution time or volume, known as a chromatogram, may be made, and from the chromatogram the compounds may be identified. For each compound, the chromatogram displays a separate curve feature also designated as a “peak”. Efficient separation of the compounds by the column is advantageous because it provides for measurements yielding well defined peaks having sharp maxima inflection points and narrow base widths, allowing excellent resolution and reliable identification and quantitation of the mixture constituents. Broad peaks, caused by poor column performance, so called “Internal Band Broadening” or poor system performance, so called “External Band Broadening” are undesirable as they may allow minor components of the mixture to be masked by major components and go unidentified.

In many HPLC applications, sample introduction is provided by fluidically decoupling a sampling volume (such as a sample loop) from a high-pressure path between the chromatographic pump and the chromatographic column. After loading a fluidic sample into the sampling volume, the sampling volume is fluidically coupled to the high-pressure path for introducing the fluidic sample into the mobile phase driven by the chromatographic pump through the chromatographic column. Such fluidic coupling and decoupling to and from the high-pressure path can cause pressure perturbations which may affect not only the chromatographic measurement (for example by leading to noise into the chromatogram) but also lifetime of certain components in the flow path, in particular the chromatographic column.

One possibility to reduce pressure effects from fluidically coupling a sampling volume for sample introduction into the chromatographic high-pressure path is the so-called “make-before-break” scheme. In make-before-break, when switching the sampling volume into the high-pressure path between pump and column, the fluidic coupling between pump and column is maintained during switching of the sampling volume, for example by providing extended stator grooves in a rotational valve, as for example disclosed in U.S. Pat. No. 8,047,060B2. In other words, make-before-break involves a switching state wherein a fluidic coupling between pump and column is maintained while already the sampling volume is switched between pump and column, so that at least for a short period of time there is a “parallel connection” of the sampling volume with a “shortcut” between the pump and column. By this, make-before-break ensures that the fluidic coupling between pump and column is always maintained during switching of the sampling volume between pump and column.

### SUMMARY

It is an object of the present disclosure to reduce pressure effects from fluidically coupling a sampling volume for sample introduction into the chromatographic high-pressure path.

In one embodiment, a switching unit is provided configured for selectively fluidically coupling a sampling volume, a sampling drive, a mobile phase drive, and a separating device. The mobile phase drive is configured for driving a mobile phase. The separating device is configured for separating a fluidic sample when comprised within the mobile phase. The sampling volume is configured for temporarily storing the fluidic sample, and the sampling drive is configured for moving fluid. In a sample load configuration, the switching unit is configured for fluidically coupling the sampling volume and the sampling drive, for moving the fluidic sample into the sampling volume. In a decouple configuration, the switching unit is configured for fluidically coupling the sampling volume between the sampling drive and the separating device, while the mobile phase drive is fluidically decoupled from the separating device. In a sample introduction configuration, the switching unit is configured for fluidically coupling the mobile phase drive, the sampling volume, and the separating device for introducing at least an amount of the fluidic sample stored in the sampling volume into the mobile phase for fluid separation by the separating device. The separating device is fluidically coupled with at least one of the mobile phase drive and the sampling drive during switching from the sample load configuration to the decouple configuration, and during switching from the decouple configuration to the sample introduction configuration. This allows maintaining a fluidic coupling of the separating device with at least one “upstream unit” such as the mobile phase drive, the sampling drive, the sampling volume. The flow to the separating device can be always maintained and may be controlled to provide a flow towards the separating device (for example “actively” by operation of the mobile phase drive, by operation of the sampling drive, and/or “passively” by applying a pressure to the sampling path exceeding a pressure of the mobile phase between the switching unit and the separating device). Thus, the switching unit may allow a “make before break” switching by providing a continuous fluidic coupling of and to the separating device in plural (preferably successive) switching states.

With respect to certain flow-through configuration is as known in the art, embodiment of the present invention allow avoiding a pressure decrease at the separating device by maintaining fluidic coupling during successive switching states and by avoiding a fluidic cut off of the separating device (which may cause bad performance and/or reduced column lifetime of the separating device in particular of chromatographic columns.

In one embodiment, in the sample load configuration, the switching unit is further configured for fluidically coupling the mobile phase drive with the separating device. This allows to provide a flow of the mobile phase from the mobile phase drive to and through the separating device independent of and parallel to the loading of the fluidic sample into the sampling volume.

In one embodiment, in the sample load configuration, the sampling drive is configured for pressurising or depressurising the fluidic sample in the sampling volume. This allows adjusting the pressure condition of the fluidic sample, for example by pressurising the fluidic sample to a value of pressure corresponding to a value of pressure of the mobile phase or, the other way around, by depressurising the fluidic sample e.g. from a value of pressure in the range of a pressure of the mobile phase to a lower pressure required for loading the fluidic sample, such as ambient pressure.

In one embodiment, the separating device is fluidically coupled with at least one of the mobile phase drive and the sampling drive during switching between the sample load configuration, the decouple configuration, and the sample introduction configuration.

In one embodiment, the separating device is fluidically coupled with at least one of the mobile phase drive and the sampling drive in each of the sample load configuration, the decouple configuration, and the sample introduction configuration.

In one embodiment, the separating device is fluidically coupled with at least one of the mobile phase drive and the sampling drive in each of the sample load configuration, the decouple configuration, and the sample introduction configuration as well as during switching between the sample load configuration, the decouple configuration, and the sample introduction configuration.

In one embodiment, in a couple configuration, the switching unit is configured for fluidically coupling the sampling volume between the sampling drive and a coupling point between the mobile phase drive and the separating device. The couple configuration may allow to pressurise the fluidic sample in the sampling volume to a pressure value of the mobile phase. Further, the couple configuration may allow Feed-Injection sample introduction, for example by operation of the sampling drive.

Pressurising or compressing the fluidic sample prior to introduction of the fluidic sample into the mobile phase may allow to reduce stress to the separation device as may result from resulting pressure ripples.

In one embodiment, the separating device is fluidically coupled with at least one of the mobile phase drive and the sampling drive during switching between the sample load configuration and the couple configuration.

In one embodiment, the separating device is fluidically coupled with at least one of the mobile phase drive and the sampling drive during switching between the couple configuration and the sample introduction configuration.

In one embodiment, the sample introduction configuration comprises a first flow-through configuration, wherein the switching unit is configured for fluidically coupling the sampling volume between the mobile phase drive and the separating device. This allows introduction of full volume of the fluidic sample as contained in the sampling volume. Further, the fluidic sample may be transported as a sample plug with the volume of the fluidic sample being substantially spatially focused and may be abutting on each side to the mobile phase. The sampling drive may be coupled to the sampling volume and fluidically coupled between the mobile phase drive and the separating device, or the sampling drive may be decoupled and not being fluidically coupled between the mobile phase drive and a separating device.

In one embodiment, the sample introduction configuration comprises a second flow-through configuration, wherein the switching unit is configured for fluidically coupling the sampling drive together with the sampling volume between the mobile phase drive and the separating device. Preferably, the sampling drive and the sampling volume coupled in a serial coupling between the mobile phase drive and the separating device.

In one embodiment, the sample introduction configuration comprises a Feed-Injection configuration, wherein the switching unit is configured for fluidically coupling the sampling drive together with the sampling volume to a coupling point between the mobile phase drive and the separating device for combining into the coupling point a flow from the sampling drive through the sampling volume with a flow of the mobile phase from the mobile phase drive. Such Feed-Injection configuration may be as for example described in US2017343520A1 by the same applicant. The Feed-Injection configuration may correspond to the couple configuration with the difference that the sampling drive can be operated for sample introduction in the Feed-Injection configuration.

Embodiments of the present invention provide a switching unit allowing selectively for both sample introduction types, Feed-Injection and flow-through configuration, with the same switching unit, thus allowing a user to select the appropriate sample introduction type for a specific application.

In one embodiment, a sample dispatcher for a fluid separation apparatus is provided. The fluid separation apparatus comprises a mobile phase drive, configured for driving a mobile phase, and a separating device configured for separating a fluidic sample when comprised within the mobile phase. The sample dispatcher comprises a sampling volume configured for temporarily storing the fluidic sample, a sampling drive configured for moving fluid, and a switching unit according to any one of the aforedescribed embodiments for selectively fluidically coupling the sampling volume, the sampling drive, the mobile phase drive, and the separating device.

In one embodiment, the sampling volume comprises at least one of a group of: a sample loop, a sample volume, a trap volume, a trap column, a fluid reservoir, a capillary, a tube, a microfluidic channel structure. While the main functionality of the sample volume is to at least temporarily store fluidic sample, the sample volume may in addition have further capabilities e.g. for sample treatment.

In one embodiment, the sample dispatcher comprises a sample aspirating unit configured for receiving the fluidic sample.

In one embodiment, the sample dispatcher comprises a sample aspirating unit configured for receiving the fluidic sample, wherein the sample aspirating unit comprises a needle and a needle seat, wherein in an open position of the sample aspirating unit the needle is configured to be separated from the needle seat in order to receive the fluidic sample, and in a closed position of the sample aspirating unit the needle is configured to be fluidically sealingly coupled with the needle seat. The needle allows to introduce fluidic sample into the sampling path, e.g. by aspirating such fluidic sample from a vessel, a vial, a conduit providing such fluidic sample e.g. in the sense of an online sampling, or the like.

In one embodiment, the sample dispatcher comprises a retaining unit configured for receiving and retaining from the sampling volume at least a portion of the fluidic sample stored in the sampling volume, wherein the retaining unit comprises different retention characteristics for different components of the fluidic sample, preferably wherein the retaining unit comprises at least one of a group of: one or more chromatographic columns, preferably at least one of a trapping column, a HILIC column, a guard column, an SPE column, one or more coated capillaries, one or more filters preferably one or more filter frits, wherein in case of plural chromatographic columns and/or coated capillaries at least two of the chromatographic columns and/or coated capillaries having a different chromatographic separation mechanism. The retaining unit can be a single unit comprising only one dedicated retaining property. Alternatively, the retaining unit may comprise plural units, which may be housed individually or combined, preferably at least some of the plural units having different retaining properties, e.g. different retention characteristics for different components. Such plural units may be arranged in parallel or in a serial manner.

In one embodiment, the switching unit comprises one or more valves, preferably at least one: a shear valve, a rotary valve comprising a rotor and a stator configured for being rotatably moved with respect to each other, a translatory valve comprising a first and a second member configured for being moved with respect to each other by a translatory movement. Typical rotational valves may comprise a rotor and a stator configured for providing a rotational movement with respect to each other in order to switch the valve between different positions. Each of the rotor and the stator, or both, may comprise one or more ports for fluidically coupling external elements to the valve, one or more static grooves configured for providing a fluidic connection between ports, wherein the static grooves will remain static when providing a rotational movement between rotor and stator, and one or more (dynamic) grooves configured for providing a fluidic connection between ports, wherein the (dynamic) grooves can be moved relative to the ports when providing a rotational movement between rotor and stator. The same applies, mutatis mutandis, when using a translatory valve with the translatory valve providing a translatory movement instead of the rotational movement (as explained for the rotational valve).

In one embodiment, the sampling drive comprises at least one of: a metering device configured for metering the fluidic sample, a pump comprising a piston movable within a piston chamber for moving the fluidic sample, a syringe pump, a reciprocating pump. The metering device is preferably configured for precisely metering a desired fluid volume. The metering device may comprise a syringe, a pump, a flow source, a proportioning valve with a pump, or any other adequate facility for metering a desired fluid volume as known in the art.

In one embodiment, the sampling drive is coupled in series with the sampling volume.

In one embodiment, a control unit configured to control operation of the sample dispatcher, preferably at least one of operation of the sampling drive and switching of the switching unit.

In one embodiment, a fluid separation apparatus is provided comprising a mobile phase drive, configured for driving a mobile phase, and a separating device configured for separating a portion of a fluidic sample when comprised within the mobile phase. The fluid separation apparatus further comprises a sample dispatcher, according to any one of the aforedescribed embodiments, configured for dispatching at least a portion of the fluidic sample to the fluid separation apparatus.

In one embodiment, a method of sample separation is provided comprising: fluidically coupling a mobile phase drive with a separating device for driving a mobile phase through the separating device; in a sample load configuration, loading a fluidic sample into a sampling volume; in a decouple configuration, fluidically coupling one end of the sampling volume to the separating device while the other end of the sampling volume is substantially blocked (e.g. disabling flow), and fluidically decoupling the mobile phase drive from the separating device; and in a sample introduction configuration, fluidically coupling the mobile phase drive, the sampling volume, and the separating device for introducing at least an amount of the fluidic sample stored in the sampling volume into the mobile phase for fluid separation by the separating device. The separating device is fluidically coupled with at least one of the mobile phase drive and the sampling drive during switching from the sample load configuration to the decouple configuration, and during switching from the decouple configuration to the sample introduction configuration.

In one embodiment, the separating device is fluidically coupled with at least one of the mobile phase drive and the sampling drive during switching between the sample load configuration, the decouple configuration, and the sample introduction configuration

In one embodiment, the separating device is fluidically coupled with at least one of the mobile phase drive and the sampling drive in each of the sample load configuration, the decouple configuration, and the sample introduction configuration.

In one embodiment, the separating device is fluidically coupled with at least one of the mobile phase drive and the sampling drive in each of the sample load configuration, the decouple configuration, and the sample introduction configuration as well as during switching between the sample load configuration, the decouple configuration, and the sample introduction configuration.

In one embodiment, loading the fluidic sample into the sampling volume comprises fluidically coupling the sampling volume with a sampling drive and operating the sampling drive for moving the fluidic sample into the sampling volume, preferably while a mobile phase drive is driving a mobile phase through a separating device.

In one embodiment, while loading the fluidic sample into the sampling volume, the mobile phase drive is fluidically coupled with the separating device.

One embodiment comprises, fluidically coupling one end of the sampling volume to the separating device while the other end of the sampling volume is substantially blocked comprises coupling one end of a sampling drive to the other end of the sampling volume and blocking the other end of the sampling device.

One embodiment comprises, after loading the fluidic sample into the sampling volume, operating the sampling drive for pressurising the fluidic sample in the sampling volume, preferably before fluidically coupling the sampling volume between the sampling drive and the separating device and fluidically decoupling the mobile phase drive from the separating device, and/or before fluidically coupling the mobile phase drive, the sampling volume, and the separating device for introducing the amount of the fluidic sample stored in the sampling volume into the mobile phase for fluid separation by the separating device.

One embodiment comprises, after introducing the amount of the fluidic sample stored in the sampling volume into the mobile phase for fluid separation by the separating device, fluidically coupling the sampling volume with the sampling drive and operating the sampling drive for depressurising the fluidic sample in the sampling volume, preferably after fluidically decoupling the sampling volume and the sampling drive from the mobile phase drive and the separating device, and preferably while the mobile phase drive is fluidically coupled to the separating device.

One embodiment corresponding to the aforedescribed couple configuration comprises, after loading the fluidic sample into the sampling volume, fluidically coupling the sampling volume between the sampling drive and the separating device, and fluidically coupling the mobile phase drive with the separating device.

One embodiment corresponding to the aforedescribed first flow-through comprises, during introducing the amount of fluidic sample into the mobile phase, fluidically coupling the sampling volume between the mobile phase drive and the separating device.

One embodiment corresponding to the aforedescribed second flow-through configuration comprises, during introducing the amount of fluidic sample into the mobile phase, fluidically coupling the sampling drive together with the sampling volume (preferably in a serial connection) between the mobile phase drive and the separating device.

One embodiment corresponding to the aforedescribed Feed-Injection configuration comprises, during introducing the amount of fluidic sample into the mobile phase, fluidically coupling the sampling drive together with the sampling volume to a coupling point between the mobile phase drive and the separating device, and combining into the coupling point a flow from the sampling drive through the sampling volume with a flow of the mobile phase from the mobile phase drive.

In one embodiment, a method of sample separation is provided comprising: fluidically coupling a mobile phase drive with a separating device for driving a mobile phase through the separating device, loading a fluidic sample into a sampling volume, fluidically coupling the sampling volume between a sampling drive and a coupling point between the mobile phase drive and the separating device, so that a pressure of the mobile phase at the coupling point pressurizes the fluidic sample, and fluidically coupling the mobile phase drive, the sampling volume, and the separating device for introducing at least an amount of the pressurised fluidic sample into the mobile phase for fluid separation by the separating device. This allows pressurising the fluidic sample without requiring an additional pump, drive (such as the sampling drive), or other pressure source, but only by fluidically coupling to the high-pressure path of the mobile phase.

One embodiment comprises, after pressurising the fluidic sample and before introducing the fluidic sample into the mobile phase, fluidically coupling the sampling volume between the sampling drive and a separating device.

One embodiment comprises, fluidically decoupling the mobile phase drive from the separating device.

One embodiment comprises operating the separating drive to further pressurise the fluidic sample. Preferably, the fluidic sample can be pressurised beyond the pressure of the mobile phase at the coupling point, which may be useful for compensating an expected or assumed pressure drop when introducing the fluidic sample into the mobile phase.

In one embodiment, fluidically coupling the mobile phase drive, the sampling volume, and the separating device for introducing the amount of the pressurised fluidic sample into the mobile phase comprises (preferably corresponding to the first flow-through configuration) fluidically coupling the sampling volume between the mobile phase drive and the separating device.

In one embodiment, fluidically coupling the mobile phase drive, the sampling volume, and the separating device for introducing the amount of the pressurised fluidic sample into the mobile phase comprises (preferably corresponding to the second flow-through configuration) fluidically coupling the sampling drive together with the sampling volume (preferably in a serial connection) between the mobile phase drive and the separating device.

In one embodiment, fluidically coupling the mobile phase drive, the sampling volume, and the separating device for introducing the amount of the pressurised fluidic sample into the mobile phase comprises (preferably corresponding to the Feed-Injection configuration) operating the sampling drive to provide a flow through the sampling volume, and combining into the coupling point the flow from the sampling drive through the sampling volume with a flow of the mobile phase from the mobile phase drive for fluid separation of the fluidic sample by the separating device.

In one embodiment, a control unit is configured to control operation of the sample dispatcher, preferably at least one of operation of the sampling drive and switching of the switching unit.

Embodiments of the present invention might be embodied based on most conventionally available HPLC systems, such as the Agilent 1220, 1260 and 1290 Infinity LC Series (provided by the applicant Agilent Technologies).

One embodiment of an HPLC system comprises a pumping apparatus having a piston for reciprocation in a pump working chamber to compress liquid in the pump working chamber to a high pressure at which compressibility of the liquid becomes noticeable.

One embodiment of an HPLC system comprises two pumping apparatuses coupled either in a serial or parallel manner. In the serial manner, as disclosed in EP 309596 A1, an outlet of the first pumping apparatus is coupled to an inlet of the second pumping apparatus, and an outlet of the second pumping apparatus provides an outlet of the pump. In the parallel manner, an inlet of the first pumping apparatus is coupled to an inlet of the second pumping apparatus, and an outlet of the first pumping apparatus is coupled to an outlet of the second pumping apparatus, thus providing an outlet of the pump. In either case, a liquid outlet of the first pumping apparatus is phase shifted, preferably essentially by 180 degrees, with respect to a liquid outlet of the second pumping apparatus, so that only one pumping apparatus is supplying into the system while the other is intaking liquid (e.g. from the supply), thus allowing to provide a continuous flow at the output. However, it is clear that also both pumping apparatuses might be operated in parallel (i.e. concurrently), at least during certain transitional phases e.g. to provide a smooth(er) transition of the pumping cycles between the pumping apparatuses. The phase shifting might be varied in order to compensate pulsation in the flow of liquid as resulting from the compressibility of the liquid. It is also known to use three piston pumps having about 120 degrees phase shift. Also other types of pumps are known and operable in conjunction with the present invention.

The separating device preferably comprises a chromatographic column providing the stationary phase. The column might be a glass, metal, ceramic or a composite material tube (e.g. with a diameter from 50 μm to 5 mm and a length of 1 cm to 1 m) or a microfluidic column (as disclosed e.g. in EP 1577012 A1 or the Agilent 1200 Series HPLC-Chip/MS System provided by the applicant Agilent Technologies). The individual components are retained by the stationary phase differently and separate from each other while they are propagating at different speeds through the column with the eluent. At the end of the column they elute at least partly separated from each other. During the entire chromatography process the eluent might be also collected in a series of fractions. The stationary phase or adsorbent in column chromatography usually is a solid material. The most common stationary phase for column chromatography is silica gel, followed by alumina. Cellulose powder has often been used in the past. Also possible are ion exchange chromatography, reversed-phase chromatography (RP), affinity chromatography or expanded bed adsorption (EBA). The stationary phases are usually finely ground powders or gels and/or are microporous for an increased surface, which can be especially chemically modified, though in EBA a fluidized bed is used.

The mobile phase (or eluent) can be either a pure solvent or a mixture of different solvents. It can also contain additives, i.e. be a solution of the said additives in a solvent or a mixture of solvents. It can be chosen e.g. to adjust the retention of the compounds of interest and/or the amount of mobile phase to run the chromatography. The mobile phase can also be chosen so that the different compounds can be separated effectively. The mobile phase might comprise an organic solvent like e.g. methanol or acetonitrile, often diluted with water. For gradient operation water and organic solvent is delivered in separate containers, from which the gradient pump delivers a programmed blend to the system. Other commonly used solvents may be isopropanol, THF, hexane, ethanol and/or any combination thereof or any combination of these with aforementioned solvents.

The sample fluid might comprise any type of process liquid, natural sample like juice, body fluids like plasma or it may be the result of a reaction like from a fermentation broth.

The fluid is preferably a liquid but may also be or comprise a gas and/or a supercritical fluid (as e.g. used in supercritical fluid chromatography—SFC—as disclosed e.g. in U.S. Pat. No. 4,982,597 A).

The pressure in the mobile phase might range from 2-200 MPa (20 to 2000 bar), in particular 10-150 MPa (100 to 1500 bar), and more particular 50-130 MPa (500 to 1300 bar).

The HPLC system might further comprise a detector for detecting separated compounds of the sample fluid, a fractionating unit for outputting separated compounds of the sample fluid, or any combination thereof. Further details of HPLC system are disclosed with respect to the aforementioned Agilent HPLC series, provided by the applicant Agilent Technologies.

Embodiments of the invention can be partly or entirely embodied or supported by one or more suitable software programs or products, which can be stored on or otherwise provided by any kind of non-transitory medium or data carrier, and which might be executed in or by any suitable data processing unit such as an electronic processor-based computing device (or system controller, control unit, etc.) that includes one or more electronic processors and memories. Software programs or routines (e.g., computer-executable or machine-executable instructions or code) can be preferably applied in or by the control unit, e.g. a data processing system such as a computer, preferably for executing any of the methods described herein. For example, one embodiment of the present disclosure provides a non-transitory computer-readable medium that includes instructions stored thereon, such that when executed on a processor, the instructions perform the steps of the method of any of the embodiments disclosed herein.

In the context of this application, the term “fluidic sample” may particularly denote any liquid and/or gaseous medium, optionally including also solid particles, which is to be analyzed. Such a fluidic sample may comprise a plurality of fractions of molecules or particles which shall be separated, for instance biomolecules such as proteins. Since separation of a fluidic sample into fractions involves a certain separation criterion (such as mass, volume, chemical properties, etc.) according to which a separation is carried out, each separated fraction may be further separated by another separation criterion (such as mass, volume, chemical properties, etc.) or finer separated by the first separation criterion, thereby splitting up or separating a separate fraction into a plurality of sub-fractions.

In the context of this application, the term “fraction” may particularly denote such a group of molecules or particles of a fluidic sample which have one or more certain properties of the group of: mass, charge, volume, chemical or physical properties or interaction, etc. in common according to which the separation has been carried out. However, molecules or particles relating to one fraction can still have some degree of heterogeneity, i.e. can be further separated in accordance with another separation criterion. As well the term “fraction” may denote a portion of a solvent containing the aforementioned group of molecules.

In the context of this application, the term “downstream” may particularly denote that a fluidic member located downstream compared to another fluidic member will only be brought in interaction with a fluidic sample after interaction with the other fluidic member (hence being arranged upstream). Therefore, the terms “downstream” and “upstream” relate to a flowing direction of the fluidic sample. The terms “downstream” and “upstream” may also relate to a preferred direction of the fluid flow between the two members being in downstream-upstream relation.

In the context of this application, the term “sample separation apparatus”, “fluid separation apparatus” or similar may particularly denote any apparatus which is capable of separating different fractions of a fluidic sample by applying a certain separation technique. Particularly, two separation apparatus may be provided in such a sample separation apparatus when being configured for a two-dimensional separation. This means that the sample is first separated in accordance with a first separation criterion, and at least one or some of the fractions resulting from the first separation are subsequently separated in accordance with a second, different, separation criterion or more finely separated in accordance with the first separation criterion.

The term “separation unit”, “separation device” or similar may particularly denote a fluidic member through which a fluidic sample is transferred, and which is configured so that, upon conducting the fluidic sample through the separation unit, the fluidic sample will be separated into different groups of molecules or particles (called fractions or sub-fractions, respectively). An example for a separation unit is a liquid chromatography column which is capable of trapping or retaining and selectively releasing different fractions of the fluidic sample.

In the context of this application, the term “fluid drive”, “mobile phase drive” or similar may particularly denote any kind of pump which is configured for forcing a flow of mobile phase and/or a fluidic sample along a fluidic path. A corresponding liquid supply system may be configured for delivery of a single liquid or of two or more liquids in controlled proportions and for supplying a resultant mixture as a mobile phase. It is possible to provide a plurality of solvent supply lines, each fluidically connected with a respective reservoir containing a respective liquid, a proportioning valve interposed between the solvent supply lines and the inlet of the fluid drive, the proportioning valve configured for modulating solvent composition by sequentially coupling selected ones of the solvent supply lines with the inlet of the fluid drive, wherein the fluid drive is configured for taking in liquids from the selected solvent supply lines and for supplying a mixture of the liquids at its outlet. More particularly, the first fluid drive can be configured to drive the fluidic sample, usually mixed with, or injected into a flow of a mobile phase (solvent composition), through the first-dimension separation apparatus, whereas the second fluid drive can be configured for driving the fluidic sample fractions, usually mixed with a further mobile phase (solvent composition), after treatment (e.g. elution) by the first-dimension separation unit through the second-dimension separation apparatus.

In the context of this application, the term “flow coupler” or “coupling point” may particularly denote a fluidic component which is capable of unifying flow components from two fluid inlet terminals into one common fluid outlet terminal. For example, a bifurcated flow path may be provided in which two streams of fluids flow towards a bifurcation point are unified to flow together through the fluid outlet terminal. At a bifurcation point where the fluid inlet terminals and the fluid outlet terminal are fluidically connected, fluid may flow from any source terminal to any destination terminal depending on actual pressure conditions. The flow coupler may act as a flow combiner for combining flow streams from the two fluid inlet terminals further flowing to the fluid outlet terminal. The flow coupler may provide for a permanent (or for a selective) fluid communication between the respective fluid terminals and connected conduits, thereby allowing for a pressure equilibration between these conduits. In certain embodiments, the flow coupler may also act as a flow splitter. A respective coupling point may be configured as one of the group consisting of a fluidic T-piece, a fluidic Y-piece, a fluidic X-piece, microfluidic junction, a group of at least 3 ports of a rotary valve, connectable together in at least one of configurations of the said rotary valve and a multi-entry port of a rotary valve.

In the context of this application, the term “valve” or “fluidic valve” may particularly denote a fluidic component which has fluidic interfaces, wherein upon switching the fluidic valve selective ones of the fluidic interfaces may be selectively coupled to one another so as to allow fluid to flow along a corresponding fluidic path, or may be decoupled from one another, thereby disabling fluid communication.

In the context of this application, the term “buffer” or “buffering” may particularly be understood as temporarily storing. Accordingly, the term “buffering fluid” is preferably understood as temporarily storing an amount of fluid, which may later be fully or partly retrieved from such unit buffering the fluid.

In the context of this application, the term “loop” may particularly be understood as a fluid conduit allowing to temporarily store an amount of fluid, which may later be fully or partly retrieved from the loop. Preferably, such loop has an elongation along the flow direction of the fluid and a limited mixing characteristic (e.g. resulting from dispersion), so that a spatial variation in composition in the fluid will be at least substantially maintained along the elongation of the loop. Accordingly, the term “sample loop” may be understood as a loop configured to temporarily store an amount of sample fluid. Further accordingly, a sample loop is preferably configured to at least substantially maintain a spatial variation in the sample fluid (along the flow direction of the sample), as e.g. resulting from a previous chromatographic separation of the sample fluid, during temporarily storing of such sample fluid.

In the context of this application, the term “retain”, “retaining”, or similar, in particular in context with “unit”, may particularly be understood as providing a surface (e.g. a coating) and/or a stationary phase configured for interacting with a fluid in the sense of having a desired retention characteristics with one or more components contained in the fluid. Such desired retention characteristics shall be understood as an intentionally applied retention, i.e. a retention beyond an unintentional side-effect. Accordingly, the term “retaining unit” may be understood as a unit in a fluidic path being configured for interacting with a sample fluid for providing a desired retention characteristic for one or more components contained in the sample fluid.

In the context of this application, the term “couple”, “coupled”, “coupling”, or similar, in particular in context with “fluidic” or “fluidically”, may particularly be understood as providing a fluidic connection at least during a desired time interval. Such fluidic connection may not be permanent but allows a (passive and/or active) transport of fluid between the components fluidically coupled to each other at least during such desired time interval. Accordingly, fluidically coupling may involve active and/or passive components, such as one or more fluid conduits, switching elements (such as valves), et cetera.

The fluid separation apparatus may be configured to drive the mobile phase through the system by means of a high pressure, particularly of at least 400 bar, more particularly of at least 1000 bar.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 illustrates a liquid chromatography system according to an exemplary embodiment.

FIG. 2A illustrates schematically an exemplary embodiment of a sample dispatcher.

FIG. 2B illustrates the sample dispatcher illustrated in FIG. 2A with a switching unit thereof in a different configuration.

FIG. 2C illustrates the sample dispatcher illustrated in FIG. 2A with the switching unit in a different configuration.

FIG. 2D illustrates the sample dispatcher illustrated in FIG. 2A with the switching unit in a different configuration.

FIG. 2E illustrates an example of a rotor and stator configuration of the switching unit of the sample dispatcher illustrated in FIG. 2A.

FIG. 3A illustrates a fluidic coupling, e.g. according to the embodiment of FIGS. 2A-2E, in an overview schematic representation, in a configuration corresponding to FIG. 2A.

FIG. 3B illustrates the fluidic coupling in a configuration corresponding to FIG. 2B.

FIG. 3C illustrates the fluidic coupling in a configuration corresponding to FIG. 2C.

FIG. 3D illustrates the fluidic coupling in a configuration corresponding to FIG. 2D.

FIG. 4A illustrates another exemplary embodiment of a switching unit.

FIG. 4B illustrates an exemplary embodiment of a sample dispatcher that includes the switching unit illustrated in FIG. 4A.

### DETAILED DESCRIPTION

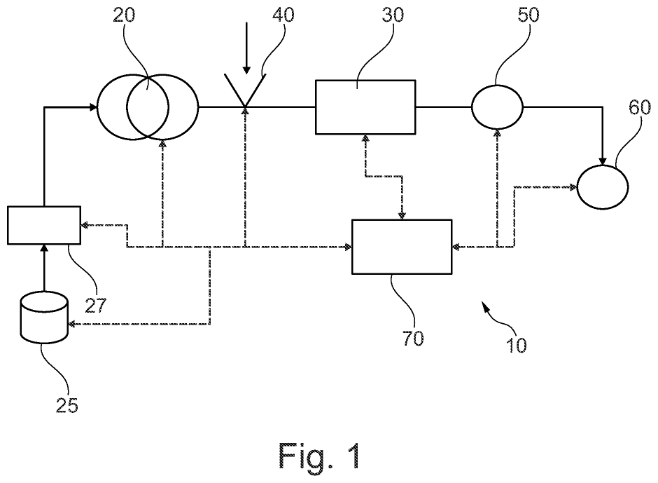

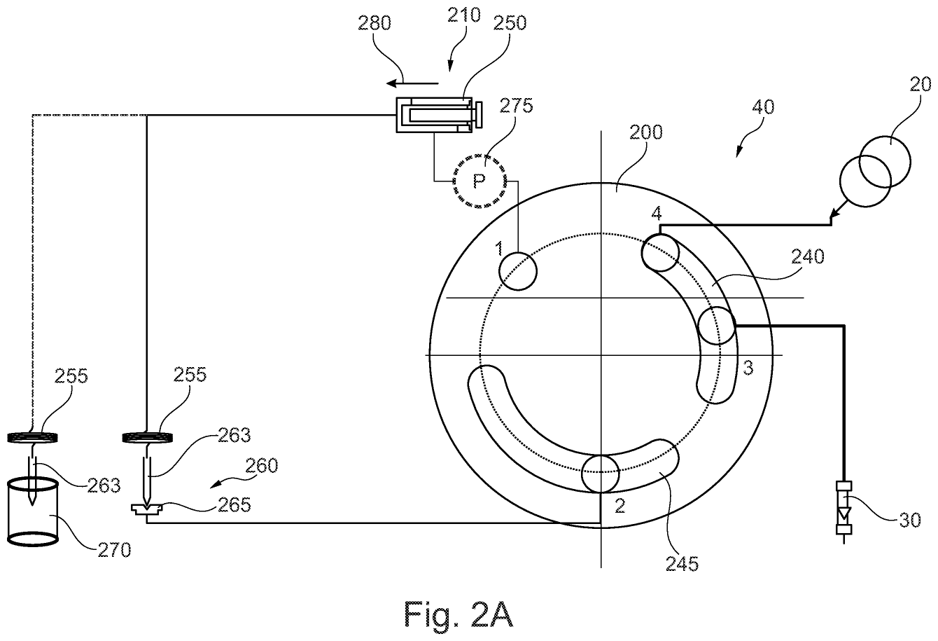

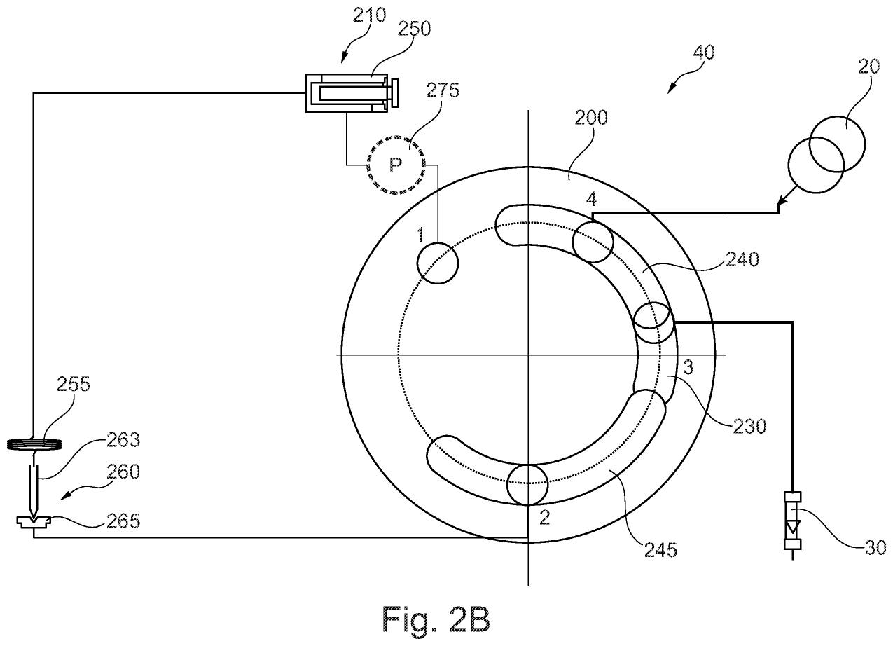

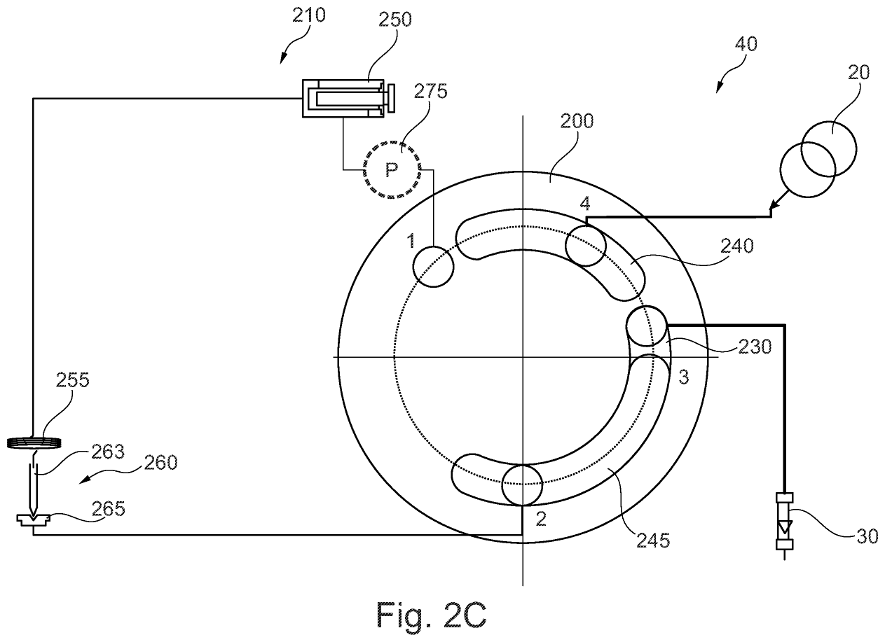

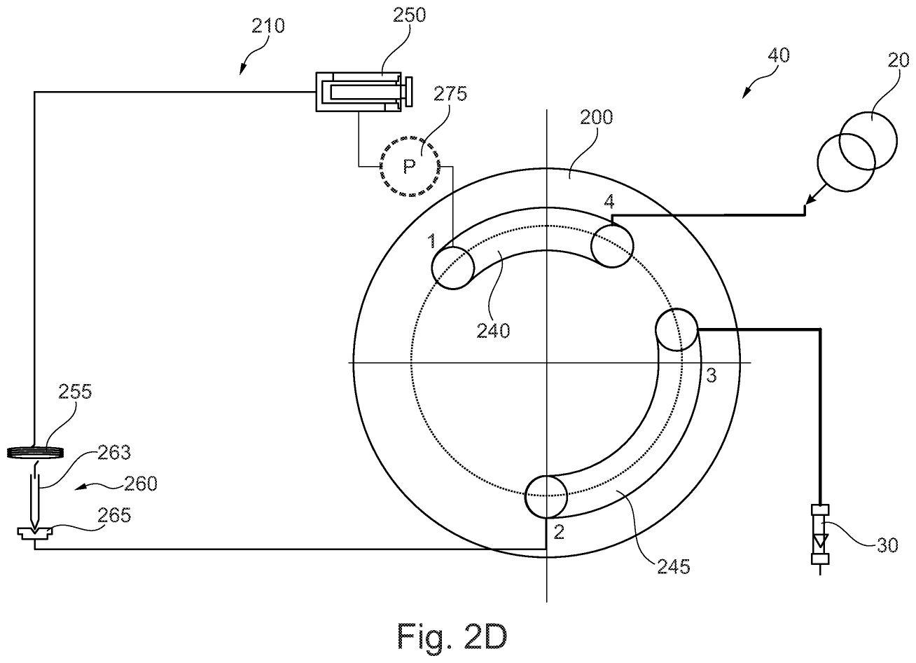

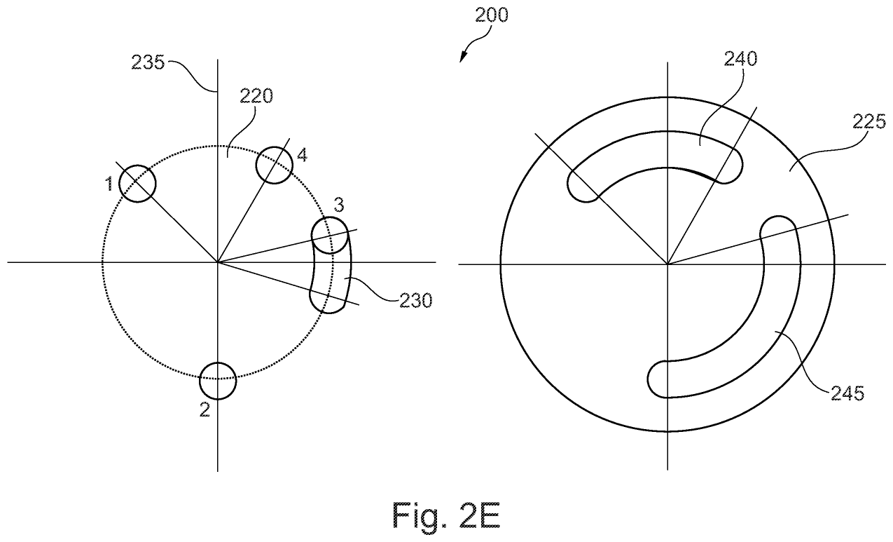

Referring now in greater detail to the drawings, FIG. 1 depicts a general schematic of a liquid separation system 10. A mobile phase drive 20 (such as a pump) receives a mobile phase from a solvent supply 25, typically via a degasser 27, which degases the mobile phase and thus reduces the amount of dissolved gases in it. The mobile phase drive 20 drives the mobile phase through a separating device 30 (such as a chromatographic column). A sample dispatcher 40 (also referred to as sample introduction apparatus, sample injector, etc.) is provided between the mobile phase drive 20 and the separating device 30 in order to subject or add (often referred to as sample introduction) portions of one or more sample fluids into the flow of a mobile phase (denoted by reference numeral 200, see also FIG. 2). The separating device 30 is adapted for separating compounds of the sample fluid, e.g. a liquid. A detector 50 is provided for detecting separated compounds of the sample fluid. A fractionating unit 60 can be provided for outputting separated compounds of sample fluid.

The separating device 30 may comprise a stationary phase configured for separating compounds of the sample fluid. Alternatively, the separating device 30 may be based on a different separation principle (e.g. field flow fractionation).

While the mobile phase can be comprised of one solvent only, it may also be mixed of plurality of solvents. Such mixing might be a low pressure mixing and provided upstream of the mobile phase drive 20, so that the mobile phase drive 20 already receives and pumps the mixed solvents as the mobile phase. Alternatively, the mobile phase drive 20 might be comprised of plural individual pumping units, with plural of the pumping units each receiving and pumping a different solvent or mixture, 3 so that the mixing of the mobile phase (as received by the separating device 30) occurs at high pressure und downstream of the mobile phase drive 20 (or as part thereof). The composition (mixture) of the mobile phase may be kept constant over time, the so-called isocratic mode, or varied over time, the so-called gradient mode.

A data processing unit 70, which can be a conventional PC or workstation, might be coupled (as indicated by the dotted arrows) to one or more of the devices in the liquid separation system 10 in order to receive information and/or control operation. For example, the data processing unit 70 might control operation of the mobile phase drive 20 (e.g. setting control parameters) and receive therefrom information regarding the actual working conditions (such as output pressure, flow rate, etc. at an outlet of the pump). The data processing unit 70 might also control operation of the solvent supply 25 (e.g. monitoring the level or amount of the solvent available) and/or the degasser 27 (e.g. setting control parameters such as vacuum level) and might receive therefrom information regarding the actual working conditions (such as solvent composition supplied over time, flow rate, vacuum level, etc.). The data processing unit 70 might further control operation of the sample dispatcher 40 (e.g. controlling sample introduction or synchronization of the sample introduction with operating conditions of the mobile phase drive 20). The separating device 30 might also be controlled by the data processing unit 70 (e.g. selecting a specific flow path or column, setting operation temperature, etc.), and send—in return—information (e.g. operating conditions) to the data processing unit 70. Accordingly, the detector 50 might be controlled by the data processing unit 70 (e.g. with respect to spectral or wavelength settings, setting time constants, start/stop data acquisition), and send information (e.g. about the detected sample compounds) to the data processing unit 70. The data processing unit 70 might also control operation of the fractionating unit 60 (e.g. in conjunction with data received from the detector 50) and provides data back. The data processing unit 70 might also process the data received from the system or its part and evaluate it in order to represent it in adequate form prepared for further interpretation.

FIG. 2 illustrate schematically an exemplary embodiment of the sample dispatcher 40, which may be part of the liquid separation system 10. For the sake of simplicity, the representation of FIG. 2 shall only depict such parts and components required for explaining function and operation of the sample dispatcher 40. FIGS. 2A-2D illustrate operation of the sample dispatcher 40, while FIG. 2E details a preferred embodiment of rotor and stator configuration.

Starting with FIG. 2A, the sample dispatcher 40 (as generally shown in FIG. 1) is provided by a switching unit 200 for selectively fluidically coupling the mobile phase drive 20, the separating device 30, and a sampling path 210.

The switching unit 200 may be embodied by a rotary valve, as best visible in the separated representation of FIG. 2E, having a stator 220 and a rotor 225. In rotary valves, as well known in the art, the stator 220 and the rotor 225 can be rotated with respect to each other, with typically the stator 220 being held in place while the rotor 225 can be rotated, for example as driven by an actuator and/or motor (not shown or further detailed herein).

In the embodiments of FIGS. 2, the stator 220 has four ports 1-4, each allowing to fluidically couple with a respective component (e.g. as illustrated in FIGS. 2A-D). A stator groove 230 extends from port 3 in the direction towards port 2. In the example here and with respect to a line 235 (representing the ordinate in FIG. 2E), port 1 is located at −45°, port 2 at +−180°, port 3 at 75°, and port 4 at 30°, and stator groove 230 is extending from about 75°-105°

The rotor 225 in the embodiments of FIG. 2 comprises a first groove 240 (extending about 75°) and a second groove 245 (extending about 105°).

Turning back to FIG. 2A, the sampling path 210 is comprised by a sampling drive 250, a sampling volume 255, and a sampling unit 260. The sampling unit 260 comprises a needle 263 and a seat 265. The needle 263 can be removed from the seat 265, for example as schematically depicted (dotted lines) on the left-hand side of FIG. 2A, for being immersed into a sampling container 270 (e.g. a sample vial) containing a fluidic sample (such as a sample liquid). When the needle 263 is positioned within and into the seat 265, a fluid tight connection between needle 263 and seat 265 can be provided, thus providing a fluid tight sampling unit 260 within the sampling path 210.

For aspirating the fluidic sample e.g. from the container 270, the needle 263 is removed from the seat 265 and immersed into the container 270 (dotted line). By operation of the sampling drive 250, fluidic sample from the container 270 can be aspirated via the needle 263 and transported into the sampling volume 255, as well known in the art. The needle 263 can then be returned back and situated into the seat 265 (solid line).

In the exemplary embodiment of FIGS. 2, the sampling path 210 is coupled on one side to port 1 and on the opposing side to port 2 of the stator 220, so that the sampling drive 250 is an integral part of the sampling path 210. However, the sampling drive 250 may also become decoupled from the sampling path 210, e.g. during certain switching configurations, for example as described and shown in WO2014199198A1 by the same applicant, preferably to avoid switching the sampling drive 250 between the mobile phase drive 20 and the separating device 30 for example during injection of the fluidic sample into the mobile phase.

The sampling path 210 may further comprise a sensor 275, such as a pressure sensor, which may be located, as shown in FIGS. 2, between the sampling drive 250 and port 1, or at any adequate location either within the sampling path 210 or fluidically coupled thereto.

FIG. 2A shows a so-called sample load configuration, allowing on one hand loading fluidic sample into the sampling volume 255, while at the same time the mobile phase drive 20 is coupled via the first groove 240 to the separating device 30. The fluidic path between the mobile phase drive 20 and the separating device 30 represents a high-pressure (flow) path, typically at a pressure in the range of several hundred bars up to 2000 bar and even beyond. In contrast thereto, the sampling path 210—at least during loading of the fluidic sample—is typically at about ambient pressure.

After aspirating the fluidic sample into the sampling volume 255 and returning the needle 263 into the needle seat 265 in a fluid tight manner, the fluidic sample may be pressurised (in the configuration shown in FIG. 2A) by operation of the sampling drive 250. As one side of the sampling drive 250 is coupled to port 1, which in the configuration of FIG. 2A is blocked (i.e. port 1 is not fluidically coupled with any other port or component, thus representing a blockage), and also the other end of the sampling path 210 is blocked (as port 2 is only coupled with the second groove 245 which, however, is not fluidically coupled with any other port or component, thus also representing a blockage), operation of the sampling drive 250, for example by moving a piston in the direction of arrow 280, compresses the sampling path 210 and thus the fluidic sample within the sampling volume 255.

Pressurising the fluidic sample may be controlled for example by usage of the sensor 275 allowing to determine a current value of the pressure in the sampling path 210. Alternatively or in addition, pressurisation may be executed based on knowledge of the actual conditions in the sampling path 210 (for example knowledge about the liquid content within the sampling path 210, in particular volumes and characteristics of such liquid content, and/or elasticity of the sampling path, et cetera), and/or historical data (e.g. effects of previous pressurising for example resulting in pressure ripples when introducing the fluidic sample into the high-pressure path of the mobile phase, as will be explained later), and/or simulation, et cetera.

The fluidic sample may be pressurised to the pressure of the mobile phase (in the high-pressure path between the mobile phase drive 20 and the separation device 30) or within a certain range below are beyond such pressure. Pressurising the fluidic sample to a pressure value higher than a pressure of the mobile phase may be useful to compensate for an (e.g. expected) pressure drop when introducing the fluidic sample into the mobile phase. Such over-pressurising may be done iteratively by, in a first cycle, pressurising the fluidic sample to a first pressure value higher than the pressure of the mobile phase and determining a pressure ripple when introducing the fluidic sample into the mobile phase, and in a successive cycle varying (with respect to the first pressure value) the pressure value for over-pressurising of the fluidic sample in order to avoid or at least reduce such pressure ripple. Again, this may be executed iteratively and adaptively in order to minimise the resulting pressure ripple resulting from introducing the fluidic sample into the mobile phase.

FIG. 2B shows the switching unit 200 in a “couple configuration”. Such couple configuration can be assumed, when starting from the sample load configuration of FIG. 2A and rotating rotor 225 in anticlockwise direction. In the couple configuration, the stator groove 230 is coupling between the first groove 240 and the second groove 245, so that the first groove 240, the stator groove 230 and the second groove 245 represent a common “enlarged” groove. Accordingly, the separating device 30 remains fluidically coupled with the mobile phase drive 20 during switching from the sample load configuration (of FIG. 2A) to the couple configuration (of FIG. 2B).

In the couple configuration of FIG. 2B, the “enlarged” groove (provided by the first groove 240, the stator groove 230 and the second groove 245) fluidically couples ports 2-4 together, so that ports 2-3 can be considered as a single coupling point. In such coupling point (of ports 2-4) the sampling path 210 couples with one side (namely the side coupled to port 2) in the high-pressure path between the mobile phase drive 20 and the separating device 30.

In the couple configuration of FIG. 2B, the pressure condition at the coupling point (ports 2-4) is the same for the coupling end of the sampling path 210 and for the mobile phase in the high-pressure path. In case the pressure in the sampling path 210 is substantially the same as at the coupling point, there will be no flow from the sampling path 210 into the high-pressure path, or the other way around, and also there will be no change in the pressure of the sampling path 210. In case the pressure in the sampling path 210 is smaller than at the coupling point, and given that the sampling path 210 at port 1 is blocked, the sampling path 210 will be pressurised (from the high-pressure path) until an equilibrium is reached (typically when the sampling path 210 has substantially the pressure of the high-pressure path at the coupling point). Accordingly, when the pressure in the sampling path 210 is higher than at the coupling point, this will result in a flow from the sampling path 210 into the high-pressure path.

The couple configuration of FIG. 2B represents a “Feed-Injection” position or configuration as for example described in the aforementioned US2017343520A1 by the same applicant. Such Feed-Injection position allows introducing fluidic sample from the sampling volume into the mobile phase for sample separation by the separating device 30, by combining a flow from the sampling path 210 with a flow of the mobile phase from the mobile phase drive 20. Such fluidic sample introduction can be operated and controlled in particular dependent on the pressure condition at the coupling point (ports 2-4) and the pressure in the sampling path 210.

Controlling the pressure in the sampling path 210, for example by means of the sampling drive 250, thus allows controlling the introduction of the fluidic sample into the mobile phase, in particular with respect to a volume of fluidic sample introduced over time.

For example, by operating the sampling drive 250 to rapidly pressurise the sampling path 210 allows to rapidly introduce a certain volume of fluidic sample into the mobile phase (for sample separation by the separating device 30), for example in the sense of a so-called sample plug (i.e. during sample introduction, the introduced liquid volume flown from the coupling point towards the separating device 30 is substantially, e.g. either fully or to a higher extent, provided by the fluidic sample). Such sample plug introduction corresponds to the so-called “flow-through injection”, as described e.g. in the aforementioned US20160334031A1 by the same applicant. Alternatively, the sampling drive 250 may be operated in a way that the flow from the sampling point (towards the separating device 30) is a combined flow with substantial contributions of liquid content from the sampling path 210 and the mobile phase provided from the mobile phase drive 20.

The couple configuration shown in FIG. 2B may be a dedicated position to be assumed by the switching unit 200, e.g. for providing a Feed-Injection sample introduction as aforedescribed. Alternatively, the couple configuration of FIG. 2B may only represent an intermediate position, for example when rotating the rotor 225 from the sample load configuration of FIG. 2A towards a “decouple configuration” depicted in FIG. 2C (illustrated below). In other words, the immediate position may merely represent a configuration of the switching unit 200 as resulting from rotating the rotor 225 with respect to the stator 220 and may thus not have a desired functionality.

In a “decouple configuration” shown in FIG. 2C, the rotor 225 is further rotated anticlockwise (with respect to the positions shown in FIGS. 2A and 2B). The “enlarged” groove of FIG. 2B is now “interrupted”. While stator groove 230 together with the second groove 245 still couple between ports 3 and 2, the first groove 240 is now decoupled from port 3 (and is still decoupled from port 1). Port 3 is now “isolated” from other ports of the switching unit 200, and accordingly the mobile phase drive 20 (coupling to port 4) is fluidically separated from the separating device 30 (coupling at port 3) as well as from the sampling path 210 (coupling between ports 1 and 2). At the same time, the sampling path 210 is fluidically coupled via ports 2 and 3 to the separating device 30. Accordingly, the separating device 30 remains coupled with the sampling path 210 and thus with the sampling drive 250 during switching from the couple configuration (FIG. 2B) into the decouple configuration (FIG. 2C).

The purpose of the decouple configuration of FIG. 2C will be understood and explained later when illustrating different operation models of the switching unit 200 of the sample dispatcher 40.

FIG. 2D illustrates a sample introduction configuration corresponding to the so-called “flow-through injection”, as described e.g. in the aforementioned US20160334031A1 by the same applicant. The sampling volume 255 (comprising the fluidic sample) is now switched between the mobile phase drive 20 and the separating device 30, so that the fluidic sample will be transported and driven by the mobile phase drive 20 through the separating device 30 (for fluidic separation of the fluidic sample by the separating device 30). In the exemplary embodiment of FIG. 2D, the first groove 240 is coupling between ports 1 and 4, thus coupling the mobile phase drive 20 to one end of the sampling path 210, while the second groove 245 is coupling between ports 2 and 3, thus coupling the other end of the sampling path 210 to the separating device 30. Accordingly, the separating device 30 remains coupled with the sampling path 210 and thus with the sampling drive 250 during switching from the decouple configuration (FIG. 2C) into the injection couple configuration (FIG. 2D).

As apparent from the different configurations resulting from rotating the rotor 225 with respect to the stator 230, the switching unit 200 represents a so-called “hybrid” switching unit in the sense of selectively allowing both different types of sample introduction, namely flow-through injection and Feed-Injection. In other words, dependent on the mode of operation either flow-through injection or Feed-Injection for introducing the fluidic sample into the mobile phase can be selected or even a sequential combination of both. For example, an amount of the fluidic sample can first be introduced by Feed-Injection and the then remaining amount of the fluidic sample can then/later be introduced by flow-through injection. It is also clear that the same sample dispatcher 40 (and accordingly the same switching unit 200) can be operated in different modes of operation dependent on the respective application. For example, the same embodiment of the sample dispatcher 40 may in one application be operated to apply flow-through injection for sample introduction, may then be operated in a different application to apply Feed-Injection for sample introduction, and may even be operated in a further application to first apply Feed-Injection for introducing an amount of the fluidic sample and then apply flow-through injection for introducing the remaining portion of the fluidic sample.

The exemplary switching unit 200 as illustrated with respect to FIG. 2 allows pressurising the fluidic sample contained in the sampling volume. For example, in one application the sampling volume is precompressed, e.g. by operation of the sampling drive 250, before sample introduction (by Feed-Injection and/or flow-through injection), for example in order to pressurise the fluidic sample to a value of pressure in the range of the pressure of the mobile phase (e.g. between the switching unit 200 and the separating device 30). In a different application not applying precompression, sample introduction (by Feed-Injection and/or flow-through injection) is applied with the fluidic sample being substantially at ambient pressure.

With the exemplary switching unit 200 as illustrated with respect to FIGS. 2, pressurising the fluidic sample can be provided by operation of the sampling drive 250 (as explained with respect to FIG. 2A) and/or by operating the switching unit 200 into the couple configuration (as explained with respect to FIG. 2B) wherein the pressurised mobile phase (as provided by the mobile phase drive 20) can pressurise the sampling path 210 when coupled at the coupling point (ports 2-4 in FIG. 2B).

In the following, examples of different modes of operation of the sample dispatcher 40 shall be explained. It is clear that beyond the given examples further applications and modes of operations are possible.

In a first mode of operation of the sample dispatcher 40, the switching unit 200 is operated into the sample load configuration of FIG. 2A for loading fluidic sample e.g. from the container 270 into the sampling volume 255. The fluidic sample may then also be precompressed by operation of the sampling drive 250. Sample introduction shall then be applied by flow-through injection, and the sampling unit 200 is operated from the sample load configuration of FIG. 2A towards the sample introduction configuration of FIG. 2D by rotating the rotor 225 relative to the stator 220. During rotation of the rotor 225 from the configuration of FIG. 2A to the configuration of FIG. 2D, rotation of the rotor 225 will also assume the configurations of FIGS. 2B and 2C. In this first mode of operation, however, the rotor 225 shall be operated to assume the configurations of FIGS. 2B and 2C only in the sense of intermediate configurations, for example by “rotating over” without substantially resting at these intermediate configurations of FIGS. 2B and 2C. In other words, while the rotor 225 will assume and rest in the configurations of FIG. 2A and FIG. 2D, i.e. rotation velocity of the rotor 225 is e.g. zero during given periods of time in the configurations of FIG. 2A and FIG. 2D, the rotor 225 will “rotate over” these intermediate configurations of FIGS. 2B and 2C e.g. with the rotation velocity at which the rotor 225 is operated. In an example, the rotor 225 may stay in each of the configurations of FIG. 2A and FIG. 2D from about 10 seconds to several minutes, while rotating over of the rotor 225 in the intermediate configurations of FIGS. 2B and 2C may take only about 10-30 ms (dependent on the operation and applicable rotational velocity of the rotor 225).

In the first mode of operation, the rotor 225 (starting from the position of FIG. 2A) passes the positions of FIGS. 2B and 2C as intermediate positions. When assuming the position of FIG. 2B and in case the fluidic sample in the sampling volume 255 has been precompressed to about the pressure of the mobile phase, the flow from the mobile phase drive 20 to the separating device 30 will continue, and the position of FIG. 2B will have substantially no influence on the sampling path 210. However, in case the fluidic sample has not been precompressed to about the pressure of the mobile phase (at the coupling point of ports 2-4), a certain flow and/or pressurisation will occur—as long as the position of FIG. 2B is assumed—dependent on the respective pressure conditions.

For example, in case the pressure of the mobile phase is higher than at the fluidic sample (in the sampling volume 255), a flow of mobile phase from the coupling point into the sampling path 210 will occur and the fluidic sample may be pressurised. Alternatively, in case the pressure of the mobile phase is lower than at in the sampling path 210, a flow from the sampling path 210 into the mobile phase will occur.

Further in the first mode of operation, the rotor 225 passes—as intermediate position—the decouple configuration of FIG. 2C, which substantially corresponds to the previous (intermediate) configuration of FIG. 2B, however, with the difference that the mobile phase drive 20 is now decoupled (from both the sampling path 210 and the separating device 30), while the sampling path 210 remains coupled with the separating device 30. After passing the intermediate configuration of FIG. 2C, the rotor 225 will assume the sample introduction configuration of FIG. 2D for introducing the fluidic sample into the mobile phase for separation by the separating device 30.

During the intermediate position of FIG. 2C, in case the pressure in the sampling path 210 is substantially the same as in the flow path between ports 3 and the separating device 30, no (additional) flow resulting from pressure equalisation will occur, and the pressure and flow conditions during assuming the intermediate position of FIG. 2C will be essentially the same as before and when assuming the following position of 2D, so that switching from the load configuration of FIG. 2A into the sample introduction configuration of FIG. 2D may occur substantially without pressure variation during the process of switching, thus allowing to avoid pressure perturbations during the process of sample introduction. In return, by controlling that the pressure conditions in the sampling path 210 substantially match with the pressure conditions of the mobile phase (between the switching unit 200 and the separating device 30) allows to avoid or at least reduce pressure perturbations when switching from sample loading (FIG. 2A) to sample introduction (FIG. 2D), and vice versa. Accordingly, in case a pressure drop is assumed to occur during the decouple configuration of FIG. 2C, operating the sampling drive 250—at least during the decouple configuration of FIG. 2C—may allow to avoid or at least reduce such assumed pressure drop, for example by moving a piston of the sampling drive 250 in the direction of arrow 280 (shown in FIG. 2A) in order to increase pressure in the sampling path 210. This may be done in an iterative fashion, for example by monitoring pressure conditions (including possible pressure perturbations) during a one switching process (i.e. moving the switching unit 200 between the positions of FIGS. 2A and 2D) and accordingly operate the sampling drive 250 in a successive switching process in order to avoid or at least reduce occurring pressure perturbations.

In certain applications, for example during a gradient mode wherein solvent composition of the mobile phase is varying over time, decoupling the mobile phase drive 20 during the intermediate position of FIG. 2C may lead to a variation in solvent composition as seen by the separating device 30. This may be compensated by adequately controlling solvent composition in order to balance such composition variation, preferably by adequately modifying solvent composition before and/or after the switching process.

In the first mode after sample introduction, the switching unit 200 may be rotated backwards to assume the loading configuration of FIG. 2A. A remaining pressure (e.g. beyond ambient pressure as may be applied for a successive sample loading) in the sampling path 210 may be reduced or removed, for example by operation of the sampling drive 250, e.g. by moving the piston of the sampling drive 250 opposite to the arrow 280. Such depressurising may help avoiding undesired pressure effects, e.g. when removing the needle 263 from the seat 265, for example for successive sample loading.

Turning to a second mode of operation of the sample dispatcher 40 for applying a Feed-Injection sample introduction. Starting again in the sample load configuration of FIG. 2A for loading from fluidic sample (e.g. from the container 270) into the sampling volume 255. The fluidic sample (contained in the sampling volume 255) is then preferably precompressed by operation of the sampling drive 250, for example so that the pressure in the sampling volume 255 substantially corresponds to the pressure of the mobile phase. The rotor 225 is then turned into the position of FIG. 2B, which represents a Feed-Injection configuration with the sampling path 210 coupling to the coupling point (ports 2-4) in the high-pressure flow path of the mobile phase between the mobile phase drive 20 and the separating unit 30. Controlling the pressure in the sampling path 210, preferably by operation of the sampling drive 250, allows combining flow of fluidic sample from the sampling path 210 with a flow of mobile phase from the mobile phase drive 20 towards the separating unit 30 (for chromatographically separating compounds of the fluidic sample contained in the mobile phase).

In a third mode of operation of the sample dispatcher 40, a combined sample introduction applying Feed-Injection as well as flow-through injection is applied. Starting again in the sample load configuration of FIG. 2A for loading from fluidic sample (e.g. from the container 270) into the sampling volume 255. The fluidic sample (contained in the sampling volume 255) is then preferably precompressed by operation of the sampling drive 250, for example so that the pressure in the sampling volume 255 substantially corresponds to the pressure of the mobile phase. The rotor 225 is then turned into the position of FIG. 2B, which represents a Feed-Injection configuration with the sampling path 210 coupling to the coupling point (ports 2-4) in the high-pressure flow path of the mobile phase between the mobile phase drive 20 and the separating unit 30. Controlling the pressure in the sampling path 210, preferably by operation of the sampling drive 250, allows combining a flow of fluidic sample from the sampling path 210 with a flow of mobile phase from the mobile phase drive 20 towards the separating unit 30 (for chromatographically separating compounds of the fluidic sample contained in the mobile phase) until a predefined amount of fluidic sample has been introduced into the mobile phase.

After sample introduction applying Feed-Injection in the third mode of operation, and for example until the thus introduced fluidic sample has been chromatographically separated by the separating unit 30 (and maybe some additional time required for equilibration et cetera), the rotor 225 may stay into the configuration of FIG. 2B, however, with the sampling drive 250 being operated that no further flow from the sampling path 210 is combined with the flow of mobile phase from the mobile phase drive 20. Alternatively to staying in the configuration of FIG. 2B, the rotor 225 may be rotated for example returning into the configuration of FIG. 2A or for assuming any other suitable configuration.

The process of sample introduction applying Feed-Injection may be applied several times in the third mode of operation, each time for introducing a certain amount of fluidic sample into the mobile phase for chromatographic separation.

For introducing any amount of fluidic sample remaining within the sampling volume 255 by applying flow-through injection, the rotor 225 is then operated to assume the configuration of FIG. 2D, as explained above with respect to the first mode of operation. In accordance with the first mode of operation and dependent on the starting position of the rotor 225, the rotor 225 will pass the positions of FIGS. 2B and/or 2C as intermediate positions.

It is clear that further modes of operation of the sample dispatcher 40 can be applied accordingly.

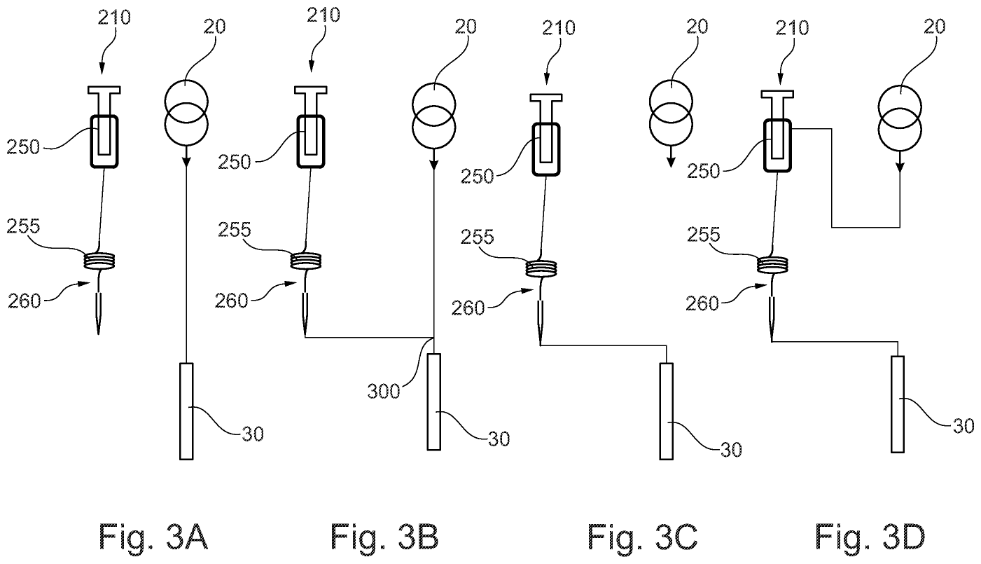

FIG. 3 shall illustrate the fluidic coupling of the mobile phase drive 20, the separating device 30, and the sampling path 210 (comprising the sampling drive 250, the sampling volume 255, and the sampling unit 260), as provided and operated by the switching unit 200, in an overview schematic representation.

FIG. 3A corresponds to FIG. 2A illustrating the load (and preferably pressurisation) configuration allowing to load the fluidic sample into the sampling volume 255 and preferably precompressing the fluidic sample, for example to a pressure range of the mobile phase. Fluidically fully decoupled and independent of the loading of the fluidic sample, the mobile phase drive 20 is fluidically coupled with and driving the mobile phase through the separating device 30. In other words, the sampling path 210 and the high-pressure path of the mobile phase between the mobile phase drive 20 and the separating device 30 are fluidically decoupled and separated from each other.

FIG. 3B corresponds to FIG. 2B illustrating the couple configuration, wherein one end of the sampling path 210 is coupling at a coupling point 300 (corresponding to the coupling point provided by ports 2-4 in FIG. 2) within the high-pressure path of the mobile phase between the mobile phase drive 20 and the separating device 30. During switching from the sample load configuration (of FIG. 3A) to the couple configuration (of FIG. 3B), the separating device 30 remains fluidically coupled with the mobile phase drive 20.

In this couple configuration, a pressure equilibration of the pressure within the sampling path 210 with a pressure of the mobile phase (at the coupling point 300) can be provided, for example in order to pressurise (i.e. to increase pressure of) the fluidic sample contained in the sampling volume 255. Alternatively or in addition, the couple configuration can be applied for providing Feed-Injection sample introduction of fluidic sample into the mobile phase by combining a flow from the sampling path 210 (preferably driven by the sampling drive 250) with a flow of the mobile phase driven by the mobile phase drive 20 and providing the combined flow towards the separating device 30.

FIG. 3C corresponds to FIG. 2C illustrating the decouple configuration wherein the sampling path 210 is fluidically coupled to the separating device 30, while the mobile phase drive 20 is fluidically decoupled. In other words, the configuration of FIG. 3C corresponds to the configuration of FIG. 3B, however, with the difference that in FIG. 3C the mobile phase drive 20 is fluidically decoupled or separated. During switching from the couple configuration (FIG. 3B) into the decouple configuration (FIG. 3C), the separating device 30 remains coupled with the sampling path 210 and thus with the sampling drive 250.

FIG. 3D corresponds to FIG. 2D illustrating the sample introduction configuration for providing flow-through injection. The sampling path 210 (either with or without the sampling drive 250) is coupled between the mobile phase drive 20 and the separating device 30, so that a flow of mobile phase is driven by the mobile phase drive 20 first through the sampling path 210 and then through the separating device 30, so that the mobile phase transports the fluidic sample contained in the sampling volume 255 through the separating device 30 for chromatographic separation. During switching from the decouple configuration (FIG. 3C) into the injection couple configuration (FIG. 3D), the separating device 30 remains coupled with the sampling path 210 and thus with the sampling drive 250.

As apparent from the aforedescribed and best visible from FIGS. 3, the separating device 30 in all of the configurations of FIGS. 2 and 3 is always fluidically coupled with at least one “upstream unit”, i.e. with either the mobile phase drive 20, the sampling path 210, with both. The flow to the separating device 30 is always maintained and may be controlled to provide a flow towards the separating device 30 (for example “actively” by operation of the mobile phase drive 20, by operation of the sampling drive 250, and/or “passively” by applying a pressure to the sampling path 210 exceeding a pressure of the mobile phase between the switching unit 200 and the separating device 30). Accordingly, the switching unit 200 of the exemplary embodiments of FIGS. 2 and 3 provide a “make before break” switching by providing a continuous fluidic coupling of and to the separating device 30 in all switching states.

It is clear for the person skilled in the art, in particular from the schematic representation of FIG. 3, that plural designs of the switching unit 200 are applicable and can be considered, using one or plural valve elements, for example of rotary, translatory or any other suitable valve type as known in the art. As an example, in an alternative design, the sampling drive 250 and/or the sampling unit 260 may be decoupled from the sampling path 210.

Further, it is clear that other elements as shown in the exemplary embodiments of the FIGS. 2-3 may be added. For example, a flush pump for flushing and/or cleaning the sampling path 210 may be provided, which may require an additional switching configuration of the switching unit 200 e.g. for a specific flushing mode.

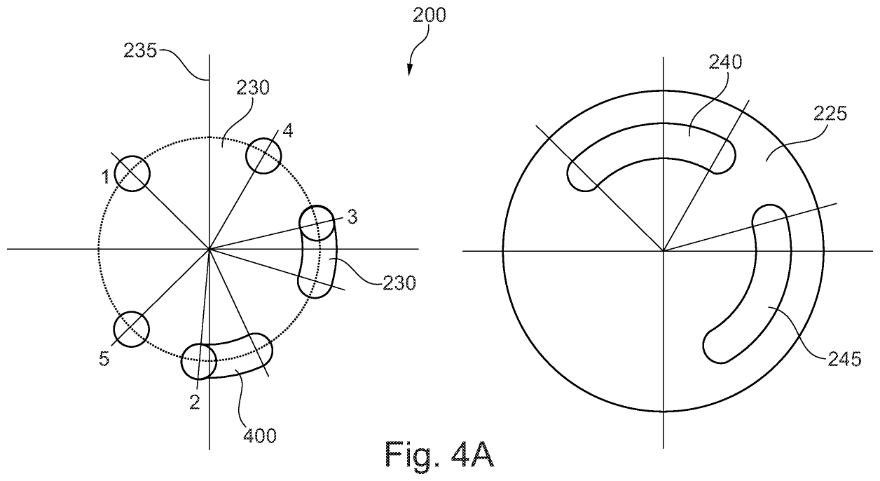

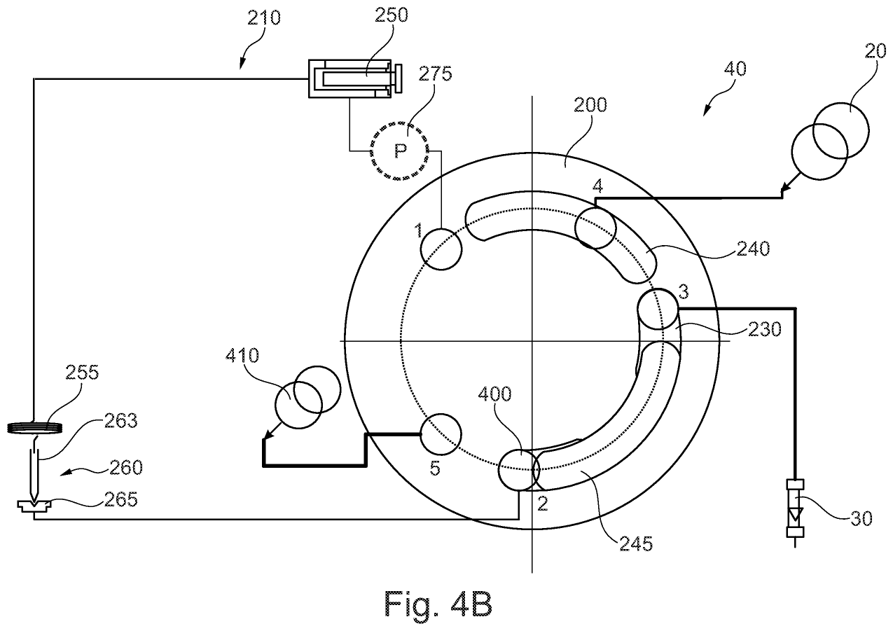

FIG. 4 illustrate another exemplary embodiment of the switching unit 200. FIG. 4A shows, represented in accordance with FIG. 2E, the stator 220 and the rotor 225 separated from each other for the sake of better understanding. The differences of the embodiment shown in FIG. 4A over the embodiment shown in FIG. 2E are the following: is the embodiment of FIG. 4A, the stator 220 comprises a further stator groove 400 and a fifth port 5, port 2 is at a slightly different location, and the second rotor groove 245 of the rotor 225 is shorter. More precisely, the further stator groove 400 extends from port 2 towards port 3 from about 155° to 185°, port 2 is located at 185°, and the second groove 245 extends also about 75° (as the first groove 240). The further stator groove 400 allows reducing overhanging rotor groove (e.g. the second groove 245) in the Feed-Injection configuration, which may help reducing cavities in order to reduce carry over and sample dispersion.

FIG. 4B exemplarily illustrates the decouple configuration corresponding to FIG. 2C and FIG. 3C. Other switching configurations such as shown and described in detail with respect to FIGS. 2A-2D can be assumed by rotation of the rotor 225 and need not be further detailed here. In the exemplary embodiment of FIG. 4B, the coupling of the various components is substantially identical as shown in FIG. 2C, however, with the difference that a flush pump 410 is coupled to port 5.

In the decouple configuration of FIG. 4B, corresponding to the embodiment shown in FIG. 2C, the mobile phase drive 20 is fluidically decoupled and separated, while the sampling path 210 is coupled with the separating device 30. As the second groove 245 in the embodiment of FIG. 4 is shorter than in the embodiment of FIGS. 2, the further stator groove 400 serves together with the stator groove 230 and the second groove 245 in between to provide the fluidic coupling between ports 2 and 3.

In accordance with the illustrations and explanations with respect to FIGS. 2, the separating device 30 remains fluidically coupled with at least one of the mobile phase drive 20 and the sampling drive 250 during switching from the sample load configuration to the couple configuration, during switching from the couple configuration to the decouple configuration, as well as during switching from the decouple configuration to the sample introduction configuration.

For flushing the sampling path 210, for example for back flushing the seat 265 when the needle 263 is removed from the seat 265, the rotor 225 can be rotated (in clockwise direction with respect to FIG. 2B) so that the second groove 245 couples between ports 5 and 2. In such configuration, the first groove 240 couples between ports 3 and 4 thus fluidically coupling the mobile phase drive 20 with the separating device 30.

In further embodiments, not detailed herein, the sampling path 210 may comprise a retaining unit, such as a trapping column, having a certain retaining property.

Reversing the flow direction through the sampling volume/or the retaining unit (for example by providing a dedicated valve or integrating such functionality into the switching unit 200, as known in the art) may allow, for example, increasing the lifetime of the retaining unit, e.g. by avoiding or reducing plugging, and/or increasing the performance of the retaining unit.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the system controller 70 schematically depicted in FIG. 1. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), application specific integrated circuits (ASICs), field-programmable gate array (FPGAs), etc. Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the system controller 70 schematically depicted in FIG. 1), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

1. A switching unit configured for selectively fluidically coupling a sampling volume, a sampling drive, a mobile phase drive, and a separating device, wherein
the mobile phase drive is configured for driving a mobile phase,
the separating device is configured for separating a fluidic sample when comprised within the mobile phase,
the sampling volume is configured for temporarily storing the fluidic sample,
the sampling drive is configured for moving fluid,
in a sample load configuration, the switching unit is configured for fluidically coupling the sampling volume and the sampling drive, for moving the fluidic sample into the sampling volume,
in a decouple configuration, the switching unit is configured for fluidically coupling the sampling volume between the sampling drive and the separating device, while the mobile phase drive is fluidically decoupled from the separating device, and
in a sample introduction configuration is configured for fluidically coupling the mobile phase drive, the sampling volume, and the separating device for introducing at least an amount of the fluidic sample stored in the sampling volume into the mobile phase for fluid separation by the separating device,
wherein the separating device is fluidically coupled with at least one of the mobile phase drive and the sampling drive during switching from the sample load configuration to the decouple configuration, and during switching from the decouple configuration to the sample introduction configuration.

2. The switching unit according to claim 1, comprising at least one of the following:
in the sample load configuration, the switching unit is further configured for fluidically coupling the mobile phase drive with the separating device;
in the sample load configuration, the sampling drive is configured for pressurising or depressurising the fluidic sample in the sampling volume;
the separating device is fluidically coupled with at least one of the mobile phase drive and the sampling drive during switching between the sample load configuration, the decouple configuration, and the sample introduction configuration;
the separating device is fluidically coupled with at least one of the mobile phase drive and the sampling drive in each of the sample load configuration, the decouple configuration, and the sample introduction configuration;
the separating device is fluidically coupled with at least one of the mobile phase drive and the sampling drive in each of the sample load configuration, the decouple configuration, and the sample introduction configuration as well as during switching between the sample load configuration, the decouple configuration, and the sample introduction configuration.

3. The switching unit according to claim 1, comprising:
in a couple configuration between the sampling drive and a coupling point between the mobile phase drive and the separating device.

4. The switching unit according to claim 3, comprising at least one of the following:
the separating device is fluidically coupled with at least one of the mobile phase drive and the sampling drive during switching between the sample load configuration and the couple configuration;
the separating device is fluidically coupled with at least one of the mobile phase drive and the sampling drive during switching between the couple configuration and the sample introduction configuration.

5. The switching unit according to claim 1, comprising at least one of the following:
the sample introduction configuration comprises a first flow-through configuration, wherein the switching unit is configured for fluidically coupling the sampling volume between the mobile phase drive and the separating device;
the sample introduction configuration comprises a second flow-through configuration, wherein the switching unit is configured for fluidically coupling the sampling drive together with the sampling volume between the mobile phase drive and the separating device;
the sample introduction configuration comprises a Feed-Injection configuration, wherein the switching unit is configured for fluidically coupling the sampling drive together with the sampling volume to a coupling point between the mobile phase drive and the separating device for combining into the coupling point a flow from the sampling drive through the sampling volume with a flow of the mobile phase from the mobile phase drive.

6. A sample dispatcher for a fluid separation apparatus, wherein the fluid separation apparatus comprises a mobile phase drive, configured for driving a mobile phase, and a separating device configured for separating a fluidic sample when comprised within the mobile phase; the sample dispatcher comprising:
a sampling volume configured for temporarily storing the fluidic sample,
a sampling drive configured for moving fluid, and
the switching unit according to claim 1 configured for selectively fluidically coupling the sampling volume, the sampling drive, the mobile phase drive, and the separating device.

7. The sample dispatcher according to claim 6, comprising at least one of the following:
the sampling volume comprises at least one of a group of: a sample loop, a sample volume, a trap volume, a trap column, a fluid reservoir, a capillary, a tube, a microfluidic channel structure;
a sampling unit configured for receiving the fluidic sample;
a sampling unit configured for receiving the fluidic sample, wherein the sampling unit comprises a needle and a needle seat, wherein in an open position of the sampling unit the needle is configured to be separated from the needle seat in order to receive the fluidic sample, and in a closed position of the sampling unit the needle is configured to be fluidically sealingly coupled with the needle seat;
a retaining unit configured for receiving and retaining from the sampling volume at least a portion of the fluidic sample stored in the sampling volume, wherein the retaining unit comprises different retention characteristics for different components of the fluidic sample, preferably wherein the retaining unit comprises at least one of a group of: one or more chromatographic columns, preferably at least one of a trapping column, a HILIC column, a guard column, an SPE column, one or more coated capillaries, one or more filters preferably one or more filter frits, wherein in case of plural chromatographic columns and/or coated capillaries at least two of the chromatographic columns and/or coated capillaries having a different chromatographic separation mechanism;
the switching unit comprises one or more valves, preferably at least one: a shear valve, a rotary valve comprising a rotor and a stator configured for being rotatably moved with respect to each other, a translatory valve comprising a first and a second member configured for being moved with respect to each other by a translatory movement;
the sampling drive comprises at least one of: a metering device configured for metering the fluidic sample, a pump comprising a piston movable within a piston chamber for moving the fluidic sample, a syringe pump, a reciprocating pump;
the sampling drive is coupled in series with the sampling volume;
a control unit configured to control operation of the sample dispatcher, preferably at least one of operation of the sampling drive and switching of the switching unit.

8. A fluid separation apparatus comprising a mobile phase drive, configured for driving a mobile phase, and a separating device configured for separating a portion of a fluidic sample when comprised within the mobile phase; the fluid separation apparatus further comprising:
the sample dispatcher according to claim 6, configured for dispatching at least a portion of the fluidic sample to the fluid separation apparatus.

9. A method of sample separation comprising:
fluidically coupling a mobile phase drive with a separating device for driving a mobile phase through the separating device,
in a sample load configuration, loading a fluidic sample into a sampling volume,
in a decouple configuration, fluidically coupling one end of the sampling volume to the separating device while the other end of the sampling volume is substantially blocked, and fluidically decoupling the mobile phase drive from the separating device, and
in a sample introduction configuration, the sampling volume, and the separating device for introducing at least an amount of the fluidic sample stored in the sampling volume into the mobile phase for fluid separation by the separating device,
wherein the separating device is fluidically coupled with at least one of the mobile phase drive and the sampling drive during switching from the sample load configuration to the decouple configuration, and during switching from the decouple configuration to the sample introduction configuration.

10. The method according to claim 9, comprising at least one of the following:
fluidically coupling the separating device with at least one of the mobile phase drive and the sampling drive during switching between the sample load configuration, the decouple configuration, and the sample introduction configuration;
fluidically coupling the separating device with at least one of the mobile phase drive and the sampling drive in each of the sample load configuration, the decouple configuration, and the sample introduction configuration;
fluidically coupling the separating device with at least one of the mobile phase drive and the sampling drive in each of the sample load configuration, the decouple configuration, and the sample introduction configuration as well as during switching between the sample load configuration, the decouple configuration, and the sample introduction configuration;
loading the fluidic sample into the sampling volume comprises fluidically coupling the sampling volume with a sampling drive and operating the sampling drive for moving the fluidic sample into the sampling volume, preferably while a mobile phase drive is driving a mobile phase through a separating device,
while loading the fluidic sample into the sampling volume, the mobile phase drive is fluidically coupled with the separating device;
fluidically coupling one end of the sampling volume to the separating device while the other end of the sampling volume is substantially blocked comprises coupling one end of a sampling drive to the other end of the sampling volume and blocking the other end of the sampling device;
after loading the fluidic sample into the sampling volume, operating the sampling drive for pressurising the fluidic sample in the sampling volume, preferably before fluidically coupling the sampling volume between the sampling drive and the separating device and fluidically decoupling the mobile phase drive from the separating device, and/or before fluidically coupling the mobile phase drive, the sampling volume, and the separating device for introducing the amount of the fluidic sample stored in the sampling volume into the mobile phase for fluid separation by the separating device;
after introducing the amount of the fluidic sample stored in the sampling volume into the mobile phase for fluid separation by the separating device, fluidically coupling the sampling volume with the sampling drive and operating the sampling drive for depressurising the fluidic sample in the sampling volume, preferably after fluidically decoupling the sampling volume and the sampling drive from the mobile phase drive and the separating device, and preferably while the mobile phase drive is fluidically coupled to the separating device;
after loading the fluidic sample into the sampling volume, fluidically coupling the sampling volume between the sampling drive and the separating device, and fluidically coupling the mobile phase drive with the separating device;
during introducing the amount of fluidic sample into the mobile phase, fluidically coupling the sampling volume between the mobile phase drive and the separating device;
during introducing the amount of fluidic sample into the mobile phase, fluidically coupling the sampling drive together with the sampling volume between the mobile phase drive and the separating device;
during introducing the amount of fluidic sample into the mobile phase, fluidically coupling the sampling drive together with the sampling volume to a coupling point between the mobile phase drive and the separating device, and combining into the coupling point a flow from the sampling drive through the sampling volume with a flow of the mobile phase from the mobile phase drive.

11. A method of sample separation comprising:
fluidically coupling a mobile phase drive with a separating device for driving a mobile phase through the separating device,
loading a fluidic sample into a sampling volume,
fluidically coupling the sampling volume between a sampling drive and a coupling point between the mobile phase drive and the separating device, so that a pressure of the mobile phase at the coupling point pressurizes the fluidic sample, and
fluidically coupling the mobile phase drive, the sampling volume, and the separating device for introducing at least an amount of the pressurised fluidic sample into the mobile phase for fluid separation by the separating device.

12. The method according to claim 11, comprising:
after pressurising the fluidic sample and before introducing the fluidic sample into the mobile phase, fluidically coupling the sampling volume between the sampling drive and a separating device,
fluidically decoupling the mobile phase drive from the separating device, and
operating the separating drive to further pressurise the fluidic sample, preferably beyond the pressure of the mobile phase at the coupling point, preferably for compensating an expected or assumed pressure drop when introducing the fluidic sample into the mobile phase.

13. The method according to claim 12, wherein fluidically coupling the mobile phase drive, the sampling volume, and the separating device for introducing the amount of the pressurised fluidic sample into the mobile phase comprises one of:
fluidically coupling the sampling volume between the mobile phase drive and the separating device;
fluidically coupling the sampling drive together with the sampling volume between the mobile phase drive and the separating device;
operating the sampling drive to provide a flow through the sampling volume, and combining into the coupling point the flow from the sampling drive through the sampling volume with a flow of the mobile phase from the mobile phase drive for fluid separation of the fluidic sample by the separating device.

14. A non-transitory program element, wherein the program element, when being executed by one or a plurality of processors, is configured to carry out or control one or more of the steps of claim 9.
